(19) United States
(12) Patent Application Publication
(10) Pub. No.: US 2014/0060698 A1
(43) Pub. Date: Mar. 6, 2014

(54) FUNNEL WITH LEVEL SENSOR

(71) Applicants: Tamara L TENNISON, Virginia Beach, VA (US); Raymond J. Brissette, JR., Virginia Beach, VA (US)

(72) Inventors: Tamara L TENNISON, Virginia Beach, VA (US); Raymond J. Brissette, JR., Virginia Beach, VA (US)

(21) Appl. No.: 14/014,321

(22) Filed: Aug. 29, 2013

Related U.S. Application Data
(60) Provisional application No. 61/694,747, filed on Aug. 29, 2012.

(51) Int. Cl. B67C 11/02

(52) U.S. Cl. CPC B67C 11/02
USPC 141/96

(57) ABSTRACT

A funnel for transferring a flowable ingredient into a receiving container and which indicates the level of the flowable ingredient in the receiving container. The input end of the funnel extends downwardly to the output end which has a smaller circumference than the input end. At least one sensor is located on the outer surface of the funnel body adjacent to the output end with each sensor located at a different distance from the input end. As the flowable ingredient fills the receiving container, the flowable ingredient is sensed by each sensor which then activates a display to provide an indication of the level of the flowable ingredient in the receiving container, with the final indication being that the receiving container is full. The final indication causes the output end to seal such that transfer of the flowable ingredient is stopped.

### CROSS REFERENCE TO RELATED APPLICATION

This Application claims the benefit of U.S. Provisional Application No. 61/694,747 filed on Aug. 29, 2012 for “FILLING DEVICE WITH MEASUREMENT INDICATION,” incorporated herein by reference in its entirety.

### BACKGROUND OF THE INVENTION

1. Field of the Invention

This invention relates generally to funnels, and more specifically to a funnel with a level sensor and automatic shut-off.

2. Description of Related Art

Funnels have been in use to transfer wet and dry ingredients from a first container to a second container. Commonly used funnels simply transfer liquids and are incapable of indicating to the user when the second container is full. For clear containers, the user can rely on visual indicators and cease the transfer process when the second container is full. However, for containers which are not clear, such visual indicators do not exist and overfilling often occurs resulting in spills. Further, if such a transfer must occur in a dark environment, visual indicators are not available.

Some attempts have been made to equip funnels with a level indicator, for examples, U.S. Pat. Nos. 953,065; 962,674; 1,243,587; 1,290,968; 1,333,756; 2,689,651; 2,715,488; 3,630,083; 4,796,470; and 4,976,297. These devices generally rely on a mechanical apparatus to indicate the level of the ingredients which are being transferred. Such apparatus will work for certain liquids but the density of the liquid will determine the success or failure. For the transfer of dry ingredients, such an apparatus will not function. For example, if a user is attempting to transfer sugar or salt from a first container to a second, a mechanical apparatus such as that described in the prior art will be buried by the sugar or salt and will not give an indication of the level of ingredient transferred.

It is an object of the invention to provide a funnel for transferring a flowable ingredient into a receiving container.

It is another object of the invention to provide a funnel for transferring a flowable ingredient into a receiving container which indicates when the receiving container is full.

It is yet another object of this invention to provide a funnel for transferring a flowable ingredient into a receiving container which indicates when the receiving container is partially full.

It is yet another object of this invention to provide a funnel for transferring a flowable ingredient into a receiving container which, upon an indication that the receiving container is full, manually or automatically closes the funnel to prevent further transfer of the flowable ingredient.

Finally, it is an object of the present invention to accomplish the foregoing objectives in a simple and cost effective manner.

The above and further objects, details and advantages of the invention will become apparent from the following detailed description, when read in conjunction with the accompanying drawings.

### SUMMARY OF THE INVENTION

The present invention addresses these needs by providing a funnel for transferring a flowable ingredient into a receiving container. The funnel has a funnel body with an inlet end and a generally tubular outlet end with the inlet end having a larger circumference than the outlet end. The funnel body has an outer surface and an inner surface, each of which extend from the inlet end to the outlet end. A first sensor element is located on the outer surface of the outlet end and a display is coupled to the first sensor element such that upon detecting the flowable ingredient, the first sensor element causes an indication on the display, indicating a first level of the flowable ingredient in the receiving container. The funnel body is formed from a generally rigid material and may preferably include a handle. The display is preferably a light caused to illuminate upon said sensor detecting the flowable ingredient. In a particularly preferred embodiment, the device includes a second sensor element on the outer surface of the outlet end, with the second sensor element located further from the inlet end of the funnel body than the first sensor element. The display is coupled to both the first and second sensor elements such that upon detecting the flowable ingredient, said second sensor element causes an indication on said display, indicating a second level of the flowable ingredient in the second container. The funnel may further include a sealing device for preventing further flow of the flowable ingredient through the outlet end. The sealing device is actuated automatically based on the display reading or actuated manually.

### BRIEF DESCRIPTION OF THE DRAWINGS

A more complete description of the subject matter of the present invention and the advantages thereof, can be achieved by reference to the following detailed description by which reference is made to the accompanying drawings in which:

FIG. 1 is a side, partially cross-sectional, view of the preferred embodiment of this invention;

FIG. 2 shows the first step in the use of the preferred embodiment of the invention;

FIG. 3 shows the second step in the use of the preferred embodiment of the invention; and

FIG. 4 shows the third step in the use of the preferred embodiment of the invention.

### ELEMENT LIST

funnel body
12 inlet end
14 outlet end
16 internal surface
18 external surface
20 sensor
22 display
24 handle
26 sealing device
28 power supply
30 discharge tube

### DETAILED DESCRIPTION OF THE PREFERRED EMBODIMENT

The following detailed description is of the best presently contemplated mode of carrying out the invention. This description is not to be taken in a limiting sense, but is made merely for the purpose of illustrating general principles of embodiments of the invention. The embodiments of the invention and the various features and advantageous details thereof are more fully explained with reference to the non-limiting embodiments and examples that are described and/or illustrated in the accompanying drawings and set forth in the following description. It should be noted that the features illustrated in the drawings are not necessarily drawn to scale, and the features of one embodiment may be employed with the other embodiments as the skilled artisan recognizes, even if not explicitly stated herein. Descriptions of well-known components and techniques may be omitted to avoid obscuring the invention. The examples used herein are intended merely to facilitate an understanding of ways in which the invention may be practiced and to further enable those skilled in the art to practice the invention. Accordingly, the examples and embodiments set forth herein should not be construed as limiting the scope of the invention, which is defined by the appended claims. Moreover, it is noted that like reference numerals represent similar parts throughout the several views of the drawings.

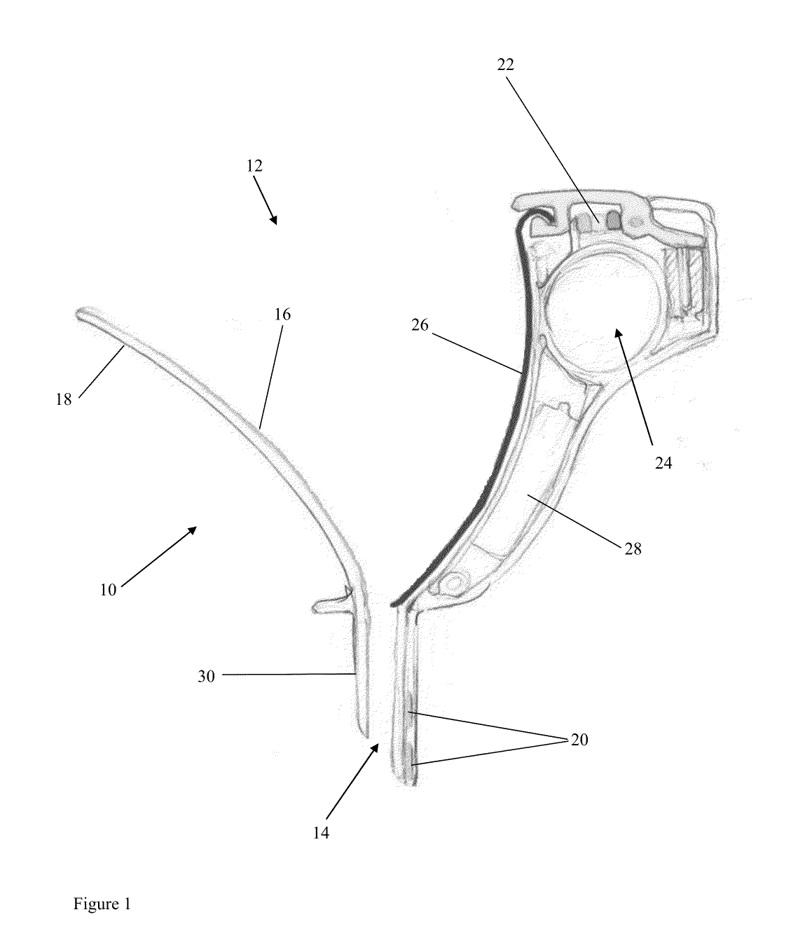

A liquid funnel for transferring flowable ingredients into a receiving container is shown in FIGS. 1-4 and is generally indicated by the numeral 10. The funnel 10 has an inlet end 12 and an outlet end 14. The inlet end 12 has a generally conical shape and leads downward into the outlet end 14. The outlet end 14 is sized and shaped to fit within and generally seal to the opening in the receiving container. The funnel 10 has an outer surface 18 and an inner surface 16 along which an ingredient to be transferred passes. A sensor 20 is located on or adjacent to the outer surface 18 of the funnel. If desired, a plurality of sensors 20 can be used to display different readings. A display 22 is coupled to the sensor 20 to indicate reading sensed by the sensor 20. A power supply 28, preferably a battery, provides power to the sensor 20 and the display 22. In a preferred embodiment, the funnel 10 includes a handle 24 to maintain stability of the funnel 10. In a particularly preferred embodiment, the funnel 10 further includes a sealing device 26 for preventing further flow from the inlet end 12 to the outlet end 14 of the funnel.

As with convention funnels, the funnel body 10 is sized and shaped for the receiving container which receives the flowable ingredient. The shape of the funnel body 10 remains generally conical with a sloping inner surface 16 such that the flowable ingredient is encouraged downward towards the outlet end 14.

The funnel body 10 is generally conical in shape but preferably includes a discharge tube 30 leading to the outlet end 16. The discharge tube 30 is open to allow passage of the flowable ingredient into the receiving container.

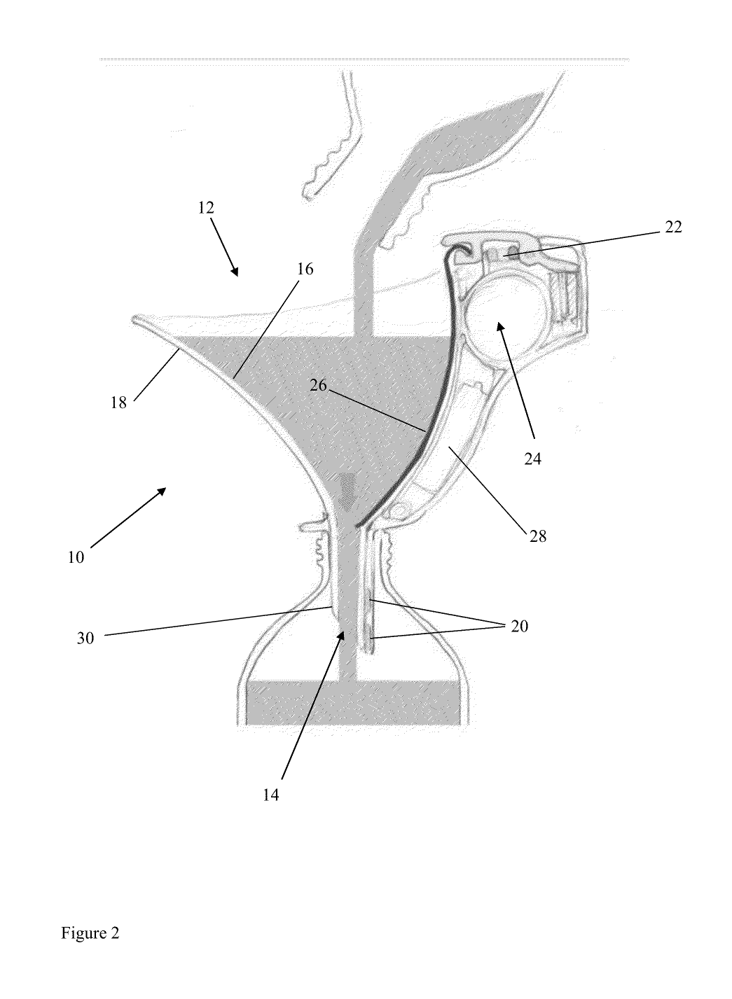

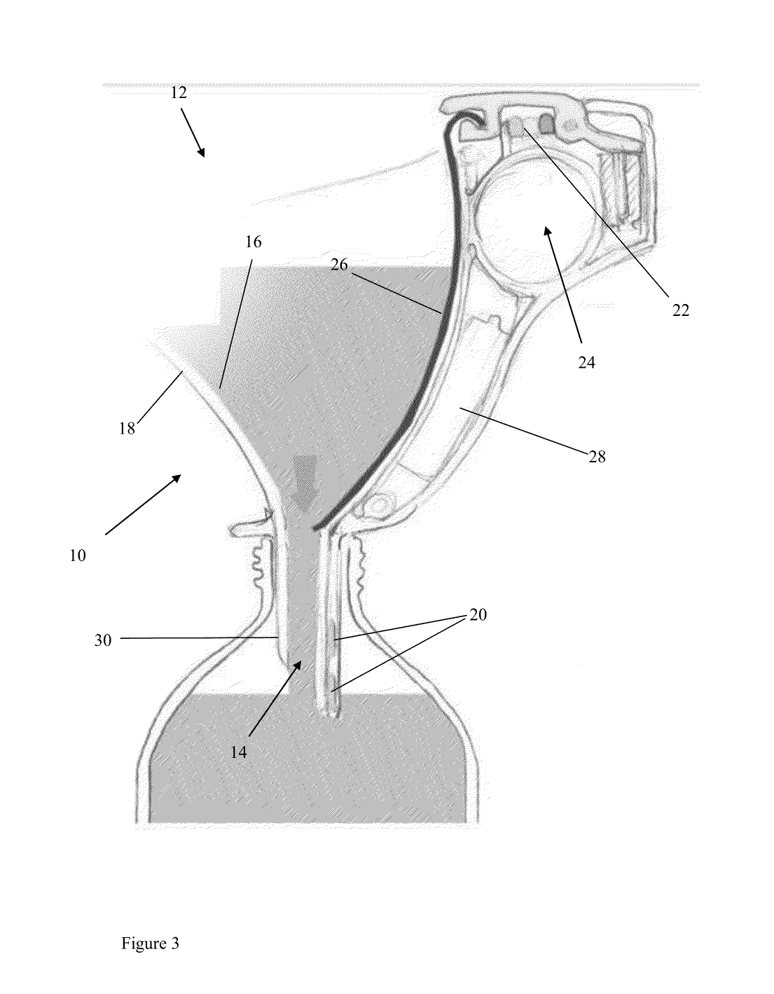

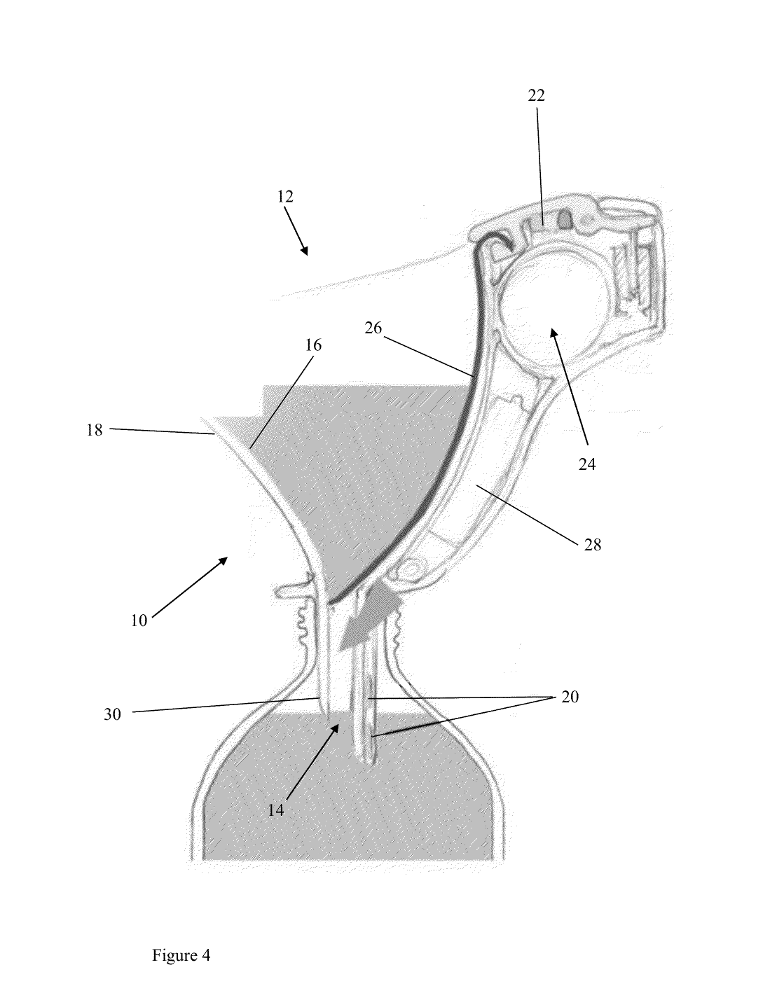

In the use and operation of the funnel 10 and in the practice of the method of the present invention, the outlet tube 30 of the funnel 10 is inserted into the fill aperture of the receiving container which is to be filled with a flowable ingredient as shown in FIG. 2. The user then proceeds to place a flowable ingredient into the inlet end 12 of the funnel, preferably while holding handle 24 to steady the funnel 10. As the flowable ingredient flows through the funnel 10 into the receiving container, the receiving container fills. Once the flowable ingredient reaches the sensor 20 as shown in FIG. 3, the display 22 indicates that the container is full. Alternatively, multiple sensors 20 indicate increasing levels of fullness as the receiving container becomes increasingly full. Once the display 22 indicates that the receiving container is full, the user ceases placing the flowable ingredient into the funnel. In a particularly preferred embodiment, the user activates a sealing device 26 to seal the output end 14 of the funnel 10, preventing further flow of the flowable ingredient into the container as shown in FIG. 4. Alternatively, the sealing device 26 is automatically actuated upon receiving indication from the sensor 20 that the receiving container is full. In another alternate embodiment, the sealing device 26 is a stopper element which extends below the outlet end 14 and which is mechanically actuated into a sealed position, either manually or automatically, upon receiving indication from the sensor 20 that the receiving container is full.

The funnel 10 can be made of appropriate softness poly plastics and/or thermoplastic rubbers that can be injection molded and/or extruded. The funnel 10 is made from a material appropriate for the intended use, for example, non-PBA for food and infant uses, anti-static materials for use with fuels and non-stick materials for liquid powders. The sensor 20 may be optical, electro-mechanical or physical and is capable of reading the intended flowable material, for example, fluids, powders or dry ingredients such as salt or sugar. The display 22 may be a single light or multiple lights. Alternatively, the display 22 may be electro-luminescent tape or wire. The display may provide audible indications based on the sensor 20 readings either in lieu of or in addition to visual indications.

The funnel 10 is particularly well suited for filling opaque containers or for filling after dark in time and places where it is difficult to see. The funnel 10 is adaptable to many different kinds of containers and fill openings. The funnel 10 is extremely useful in any household, business or location wherein a container needs to be manually filled.

Obviously, many modifications may be made without departing from the basic spirit of the present invention. Accordingly, it will be appreciated by those skilled in the art that within the scope of the appended claims, the invention may be practiced other than has been specifically described herein. Many improvements, modifications, and additions will be apparent to the skilled artisan without departing from the spirit and scope of the present invention as described herein and defined in the following claims.

What is claimed is:

1. A funnel for transferring a flowable ingredient into a receiving container, comprising:
a funnel body having an inlet end and a generally tubular outlet end wherein said inlet end has a larger circumference than said outlet end, said funnel body further having an outer surface and an inner surface, each extending from said inlet end to said outlet end;
a first sensor element on said outer surface of said outlet end;
a display coupled to said first sensor element such that upon detecting the flowable ingredient, said first sensor element causes an indication on said display, indicating a first level of the flowable ingredient in the receiving container.

2. A device as in claim 1 wherein said funnel body is formed from a generally rigid material.

3. A device as in claim 1 wherein said funnel body further includes a handle.

4. A device as in claim 1 wherein said display is a light caused to illuminate upon said sensor detecting the flowable ingredient.

5. A device as in claim 1 further comprising a second sensor element on said outer surface of said outlet end, said second sensor element being located further from said inlet end of said funnel body than said first sensor element.

6. A device as in claim 5 wherein said display is coupled to said first and second sensor elements such that upon detecting the flowable ingredient, said second sensor element causes an indication on said display, indicating a second level of the flowable ingredient in the second container.

7. A device as in claim 1 further comprising a sealing device for preventing further flow of the flowable ingredient through said outlet end.

8. A device as in claim 7 wherein said sealing device is actuated manually.

9. A device as in claim 7 wherein said sealing device is actuated automatically.
